(19) United States
(12) Patent Application Publication
(10) Pub. No.: US 2010/0280818 A1
(43) Pub. Date: Nov. 4, 2010

(54) Key Talk

(76) Inventor: Stephen R. Childers, Oklahoma City, OK (US)

Correspondence Address: DUNLAP CODDING, P.C., PO BOX 16370, OKLAHOMA CITY, OK, 73113, US

(21) Appl. No.: 12/837,065

(22) Filed: Jul. 15, 2010

Related U.S. Application Data
(63) Continuation-in-part of application No. 11/712,858, filed on Mar. 1, 2007, now abandoned.
(60) Provisional application No. 60/779,083, filed on Mar. 3, 2006.

(51) Int. Cl. G06F 17/28

(52) U.S. Cl. 704/2; 704/E11.001

(57) ABSTRACT

A method provides communication of information between a first and second communicator utilizing a plurality of lexicons. The first lexicon has a plurality of words in the language of the first communicator, each word in the first lexicon having an assigned numerical value determined by the frequency of use of the word, or an equivalent of the word, in a base language. The second lexicon functions similarly in the language of the second communicator. The numerical values are transmitted via a wired or wireless telecommunication system, whereby information is communicated between the first and second communicator by substituting numerical values common to both the first and second communicator for words representing the information communicated.

### CROSS-REFERENCE TO RELATED APPLICATIONS

The present application is a continuation-in-part of U.S. Ser. No. 11/712,858 filed Mar. 1, 2007, which claims benefit under 35 U.S.C. 119(e) of U.S. Provisional Application Ser. No. 60/779,083, filed Mar. 3, 2006, the contents of which are hereby expressly incorporated by reference herein in their entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to a key talk system, and more particularly, but not by way of limitation, to an improved process of communication among individuals having the same language or different native languages.

2. Brief Description of the Related Art

Language allows people to communicate; however, language often separates classes and countries of people. Sometimes language is utilized to preserve secrets. Whenever and wherever communication is restricted or restrained, isolation prevails and progress is hindered. When language is facilitated or improved, such as by the invention of the printing press, progress and social justice are enhanced. When communication is enhanced and simplified, all people benefit. Typically, with languages having a large vocabulary, there are a small number of words that are used most frequently to communicate the most basic concepts. Generally speaking, most societies have about 500 basic words that people typically use on a regular basis to communicate with one another, such as in the English language “hello”, “can”, “me”, “you”, “I”, “go”, “do”, “that” and “now”. Therefore, it is possible for people to communicate daily with about 500 basic words. People also have about 5,000 words that they less frequently utilize which articulate greater meaning in conversations. All people, regardless of their language, generally need to communicate the same basic concepts. However, due to the number of various and complex languages, it is difficult or even impossible for people who speak different languages to effectively communicate with one another without learning the other's language. Even communication between people speaking the same language can occasionally be a problem. Further, in an age where speed and productivity are essential, the more simplified and less time it takes to communicate, the more advantageous for businesses, people, and government. Therefore, what is needed is a method of communication that is more efficient than the current method of communication and which provides for a uniform means of communication among people having the same language and different native languages. It is to such a method of communication the present invention is directed.

### SUMMARY OF THE INVENTION

A method for providing communication of information between at least one first communicator and at least one second communicator includes the following steps. A plurality of lexicons is provided wherein at least one first lexicon is received by at least one first communicator, the at least one first lexicon having a plurality of words in the language of the at least one first communicator. Each word in the first lexicon has an assigned numerical value determined by the frequency of use of the word, or an equivalent of the word, in a base language. At least one second lexicon is received by at least one second communicator, the at least one second lexicon having a plurality of words in the language of the at least one second communicator. Each word in the second lexicon also has an assigned numerical value determined by the frequency of use of the word, or the equivalent of the word, in the base language. The numerical values are transmitted from the at least one first communicator to the at least one second communicator via a wired or wireless telecommunication system, whereby information is communicated between the at least one first communicator and the at least one second communicator by substituting numerical values common to both the at least one first communicator and the at least one second communicator for words representing the information communicated.

In one embodiment, a computer-readable storage medium stores a lexicon and a set of instructions capable of being executed by one or more computing devices, that when executed by the one or more computing devices causes the one or more computing devices to search the lexicon for a stored word matching a user-input word, and display on a display screen of the computing device, the numerical value assigned to the stored word in the lexicon matching the user-input word. The lexicon has a plurality of words in at least one language, each word in the lexicon having an assigned numerical value determined by the frequency of use of the word or an equivalent of the word in a base language.

### BRIEF DESCRIPTION OF A VIEW OF THE DRAWINGS

FIG. 1 is a schematic representation of a key talk system constructed in accordance with the present invention.

FIG. 2 is a schematic representation of another embodiment of a key talk system constructed in accordance with the present invention.

### DETAILED DESCRIPTION OF THE INVENTION

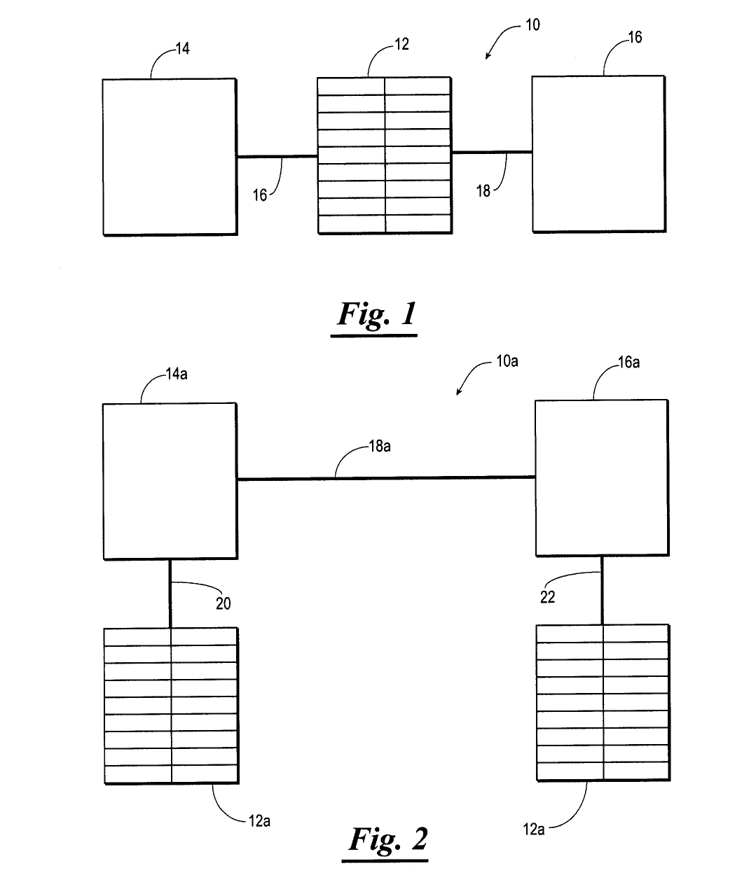

Referring now to FIG. 1, a key talk system 10 (sometimes referred to herein as “KeyTalk”) is shown constructed in accordance with the present invention. The key talk system 10 provides a method of communicating among a plurality of individuals who speak the same language or a plurality of individuals who speak different languages. In general, the key talk system 10 includes, a code lexicon 12, a first communicator 14, a second communicator 16, and a signal path 18. It should be understood that although the key talk system 10 is discussed as including the code lexicon 12, the first communicator 14, the second communicator 16, and the signal path 18, any number of communicators, code lexicons and signal paths may be utilized in the key talk system 10.

As shown in Table 1, the code lexicon 12 includes a plurality of communication codes and a plurality of words, concepts and phrases. The plurality of communication codes is represented as column 1 in Table 1. The plurality of words, concepts and phrases are represented within the plurality of horizontal rows extending between the numbers 1 and 10 in Table 1. The code lexicon 12 is organized such that an individual communication code of the plurality of communication codes is assigned to represent a corresponding word or a corresponding concept or a corresponding phrase or a corresponding combination of words, concepts and phrases of the plurality of words, concepts and phrases. Each individual communication code of the plurality of communication codes is preferably a base ten number. However, it should be understood that any base number system, such as base-2, base-4, base-5, base-6, base-8, base-12, base-16, base-20, base-24, base-32, base-60 and the like, may be utilized in accordance with the present invention.

One of the advantages of utilizing the base ten number system to represent words, concepts and phrases, is that most of the people of the world, regardless of their native language, already understand basic principals and fundamentals of base ten mathematics. This almost universal understanding of base ten mathematics can be harnessed to provide the structure for the key talk system 10. The individual communication code assigned to represent the corresponding word or the corresponding concept or the corresponding phrase or the corresponding combination of words, concepts and phrases is consistently assigned so as to represent an equivalent word, an equivalent concept, an equivalent phrase or an equivalent corresponding combination of words, concepts and phrases in a plurality of languages. For instance, if the base ten number “5” is assigned to represent the word “me” in English, the base ten number “5” is also assigned to represent the word “Ich” in German, “yo” in Spanish, “je” in French and so on. Therefore, whenever the first communicator 14 communicates the base ten number “5” to the second communicator 16, no matter what the native language of the first communicator 14 and no matter what the native language of the second communicator 16, both the first communicator 14 and the second communicator 16 will understand the meaning of the number “5” to be “me”.

The individual communication code can represent a single word, a plurality of words, a phrase or a concept. By way of example but not limitation, the individual communication code “2” can be designated to represent a phrase such as “how are you?” in English and the equivalent phrase “ [symbol] cómo es usted?” in Spanish and the equivalent phrase “wie geht es Ihnen?” in German and the equivalent phrase “comment allez-vous?” in French and so on for each known language.

Furthermore, the individual communication code can represent a word family. For instance, the individual communication code “3” can be designated to represent the word family: able, ability, abler, ablest, ably, abilities, unable or inability. By grouping similar words such as go, going, gone on one number, the 500 to 1000 key words in a language can be attached to as few as about 200 numbers, making the KeyTalk easy to learn and use. Similarly, the individual communication code can also represent a concept such as “question or inquiry”. In addition, the individual communication code can represent universal time allowing one to determine a time zone; local time or military time to determine A.M. and P.M.; dates; names of individuals and places; and locations or addresses converted into Global Positioning System coordinates and latitudes and longitudes. The system could be immediately usable in our present wars to allow everyone to communicate overnight.

The code lexicon 12 can be in the physical form of printed material or paper, such as a book, a magazine, or even flash cards having a list of the plurality of words, concepts and phrases or even pictures and a list of the corresponding individual communication codes. The code lexicon 12 can also be provided in electronic form such as on a Web site downloadable to a computing device or on a disk containing a computer program that includes the plurality of communication codes and the corresponding plurality of words, concepts and phrases. The lexicon can then be stored in an electronic memory. The electronic memory can be a hard drive of a computer, a flash drive, a ram memory, a rom memory, a portable hard drive, an mp3 player, a digital telephone, a cellular phone, a dvd, a cd-rom, a magnetic tape, a local digital network system, an internet, or any other digital device or combinations and derivations thereof.

Table 1 illustrates an abbreviated example of the code lexicon 12. The plurality of communication codes of the code lexicon 12 can be divided into a plurality of numerical categories and a plurality of numerical subcategories. Each of the plurality of numerical categories can consist of a subcategory of communication codes with each of the subcategories of communication codes within that numerical category having a mathematical commonality with the other communication codes in the same numerical category. For example, a first numerical category of communication codes can have the mathematical commonality of beginning with the number “1”. A second numerical category of communication codes can have the mathematical commonality of beginning with the number “2”. A third numerical category of communication codes can have the mathematical commonality of being divisible by the number “10”. A fourth numerical category of communication codes can have the mathematical commonality of being in excess of a first predetermined number but less than a second predetermined number. A fifth numerical category of communication codes can have the mathematical commonality of ending with a predetermined number. A sixth numerical category of communication codes can have the mathematical commonality of being a non-integer.

The plurality of words, concepts and phrases of the code lexicon 12 can also be divided into word categories. By way of example but not limitation, there may be a first word category for nouns, a second word category for verbs, a third word category for prepositions, a fourth word category for adjectives, a fifth word category for adverbs and so on.

The first numerical categories of communication codes can be assigned to include all the words in the first word categories. For instance, the first numerical category of the communication codes may be assigned to represent the first word category of nouns such that all communication codes that begin with the number “1” represents some kind of noun such as “apple”. The second numerical category of communication codes may be assigned to represent the second word category of verbs, such as “go”, so that all communication codes that begin with the number “4” will represent words that are verbs. The third numerical category of communication codes may be assigned to represent the third word category of prepositions such that all communication codes that begin with the number “6” represent prepositions. The fourth numerical category of communication codes may represent the seventh word category of adjectives such as “big”. The fifth numerical category of communication codes may be base ten numbers divisible by the number “5” and may be encoded to represent a subcategory of words that are adverbs such as “quickly”. Another numerical category of communication codes may represent pronouns and so on such as “his”.

The communication code can include a category whereby a number greater than a certain number may be encoded to represent technical terms. For example, all numbers greater than 10,000 may be encoded to represent scientific or technical terms. The number 10,001 may be encoded to represent the scientific term “physics”. Furthermore, all words related to a specific scientific area can be encoded to a range of numbers. For instance, base ten numbers from 10,000 to 11,000 may represent terms or words related to the scientific disciplines. Base ten numbers with a decimal place may be encoded so as to represent a subcategory. For example, 10,001.01 may be encoded to represent the subcategory of science known as physics or, 10,001.01 may be encoded to represent the subcategory of physics such as quantum mechanics. In a similar manner, other ranges of numbers and decimal places could be encoded to represent other disciplines and subcategories of disciplines such as medicine, religion, art, entertainment, business, technology, sports or any other areas of information. Numbers beginning with a certain prefix or symbol may be encoded to represent the actual number. For example, #1,897.009 may be encoded to represent the number 1,189.009. Therefore, a quick reference to the code lexicon 12 immediately indicates the nature of the information being conveyed. The most commonly utilized words may be encoded with the lowest numbers or most memorable numbers. In other words, the ability to apply universally known mathematical structure and principals to language would allow for an easily learned global language more precise and efficient than the currently employed ad hoc plethora of languages worldwide.

TABLE 1

| | Key Talk | | | |
|---|---|---|---|---|
| | English | German | Spanish | French |
| 1 | apple | apfel | manzana | pomme |
| 2 | how are you? | wie geht es ihnen | cómo es usted | comment allez vous |
| 3 | able | fähig | capaz | capable |
| 4 | go | gehen | vaya | allez |
| 5 | me | ich | yo | ve |
| 6 | of | von | de | de |
| 7 | big | groβ | grande | grand |
| 8 | his | siens | el suyo | sien |
| 10 | quickly | schnell | rápidamente | rapidement |
| 10,000 | scientific terms | | | |
| 10,000.1 | Physics | | | |
| 10,000.01 | quantum mechanics | | | |
| #1,897.009 | 1,897.009 | 1,897.009 | 1,897.009 | 1,897.009 |

The signal path 18 may be an acoustical signal path, a visual signal path, a wired signal path, or a wireless signal path. The signal path 18 can be logical and/or physical links and/or wireless links between various software and/or hardware utilized to implement the present invention. The physical links could be acoustic, optic fiber, copper wire, coaxial cable communication links. The signal path 18 does not have to be a single signal path but may be multiple signal paths. In addition, it should be understood that the various information does not always have to flow between the components of the present invention in the exact manner shown provided the information is generated and received to accomplish the purposes set forth herein. The communication code may be transmitted vocally, visually, electronically (either analog or digital) or via telephone, television, radio, e-mail, post, text message or by combinations and derivations thereof. For example, the communication code can be transmitted via the tone created when one of the ten numbers and two symbols on the typical key pad of a functioning telephone is depressed.

The communication code may even be recorded by any means available such that the communication code may be transmitted at a later date or time. Furthermore, key talk system 10 has the advantage of being easily communicated visually. For instance, the first communicator 14 whose native language may be English can easily visually communicate the word “apple” to a second communicator 16 whose native language may be French by simply extending one finger so as to be visible to the second communicator 16 to indicate “apple”.

In use, the first communicator 14 can utilize visual signals, his voice and/or a first acoustical device, a first analog electronic device, or a first digital electronic device. For instance, the first communicator 14 can use a microphone and speaker, a walkie talkie, an analog magnetic recording device, a digital recording device, a telephone, a cellular phone, or a computer system or combinations and derivation of same. The second communicator 16 can utilize a second microphone and speaker, a second walkie talkie, a second analog magnetic recording device, a second digital recording device, a second telephone, a second cellular phone, or a second computer system or combinations and derivations of same. The first communicator 14 and the second communicator 16 are coordinated such that the first communicator 14 and the second communicator 16 are capable of receiving and transmitting, via the signal path 18, acoustical, electronic, or visual information between the first communicator 14 and the second communicator 16. The first communicator 14 and the second communicator 16 are provided with the code lexicon 12. The communication code is transmitted to the second communicator 16 via the signal path 18. The second communicator 16 is provided with the code lexicon 12 for translating the communication code to the corresponding word, phrase or concept assigned to the communication code. The code lexicon 12 may then assign a communication code as a response to the first communicator 14 and transmit another communication code back to the first communicator 14 via the signal path 18. The electronic memory containing the code lexicon 12 can be integrated into the first communicator 14 and/or the second communicator 16 so as to be accessible to the first communicator 14 and the second communicator.

The communication code may also be decoded unaided by the second communicator 16. For those recipients unable to transition from the old form of communication to this method of communicating, the communication code may be decoded by an information processing system. It is anticipated that as the method of communicating becomes more and more widely accepted and utilized, there will be a lesser need for code books and information processing systems to decode the communication code. The information processing system can be, by way of example but not limitation, the internet, a network of computers, a single computer, a portable computer, a handheld electronic translator or any other device capable of decoding the number and conveying to the recipient the meaning of the number.

In order to more fully and clearly describe the present invention, the following examples are given. However, it is to be understood that the examples are for illustrative purposes and are not to be construed as limiting the invention disclosed herein.

The goal of KeyTalk is to promote understanding, especially between different cultures and languages, and speed the transmission and use of knowledge between all people. KeyTalk can break down any barriers of language between people. Below are some examples of ways this idea might be designed and used for religious and ethnic understanding. The following faiths are paraphrased and translated into KeyTalk.

Christianity
Mathew 7:12.
As you want others to do to you, do to them.
KeyTalk: 2 29 31 21 26 7 26 7 26 29 7 26 24

Islam
From the Koran: The Fourth Hadith of an-Nawawe 13.
No one of you is a believer until he loves for his brother what he loves for himself.
KeyTalk: 12 20 15 1 5 28 12 16 9 12 6 32 12 16 9 12.

Hindu
From the Laws of Manu
They who hurt others to gain, never find good.
Those who do not hurt others and do good find good.
KeyTalk: 24 34 13 21 26 10 7 18 8 11. 24 34 7 9 13 21 3 7 11 8 11.

Buddhism
Dana Yarga 5:18
Do not hurt others in ways that hurt you.
KeyTalk: 7 18 13 21 14 30 23 13 29.

Confucianism
Lun Yu Chapter 6 Vs. 28
The good person does for others what he wants them to do for him.
KeyTalk: 25 11 22 7 9 21 32 12 31 24 26 7 9 12.

Shinto
Jinja Shinto
Do for others with no thought for getting.
KeyTalk: 7 9 21 33 17 27 9 10.

Taoism
Tao Te Ching
Do good for others.
KeyTalk: 7 11 9 21.

Judaism
Leviticus 19:18
You are to love others as you love you.
KeyTalk: 29 4 26 16 21 2 29 16 21.

Other areas of use:
Business; education; law; literature; arts; politics; government; science; technology.

Because this language is made up of combinations of only 10 digits, 0-9, it can quickly and easily be learned by anyone. The following numbering system used is only an example and is not meant to be the final developed system. The final system for every day communication can be about 300 numbers with another 200 for more descriptive words. For example:

1=a; 2=as; 3=and; 4=are; 5=believer; 6=brother; 7=do/does; 8=find; 9=for; 10=get/getting; 11=good; 12=he/his/him/himself; 13=hurt; 14=in; 15=is; 16=love/loves; 17=no; 18=not; 19=of; 20=one; 21=others; 22=person; 23=that; 24=them/they; 25=the; 26=to; 27=thought; 28=until; 29=you; 30=ways; 31=want/s; 32=what; 33=with; 34=who.

In one embodiment, the lexicon contains a plurality of words in at least one language, wherein each word in a single language has an assigned numerical value determined by the frequency of use of that word, or an equivalent of that word, in a base language. In this manner, words used the most often can have a smaller numerical value and be easier to use, learn and remember. The numerical values can be integers having any format such as base 10, base 2, base 4, base 5, base 6, base 8, base 12, base 16, and base 20. However, when the numerical values have a base 10 format, particularly when the numerical values are whole numbers, this simplifies and reduces the numerical input required to communicate information.

The base language used to determine the word frequency of use can be any language. In some embodiments, however, the base language is English and the word use frequency is determined by the Brown University Standard Corpus of Present-Day American English⁽¹⁾ commonly referred to as the “Brown Corpus”. The Brown Corpus was compiled in the 1960s by Henry Kucera and W. Nelson Francis at Brown University, Providence, R.I. as a general corpus in the field of corpus linguistics. It compiled about a million words drawn from a variety of sources and subjected to computational analyses.

Other later corpora and statistical analyses, such as the Lancaster-Oslo/Bergen Corpus⁽²⁾ and Winthrop Nelson Francis and Henry Kucera studies⁽³⁾ can also be used to determine the word frequency of use for purposes of compiling the lexicons.

An interesting finding of these statistical studies is that graphing words in order of decreasing frequency of occurrence results in a hyperbola wherein the frequency of the n^{th} most frequent word is roughly proportional to 1/n. Thus words like “the,” “of” and “a” constitute a large percentage of the Brown Corpus, while about half the total vocabulary occur only once in the corpus. This simple rank-vs-frequency relationship has been found in many types of data studied in the physical and social sciences and is commonly known as Zipf's Law after linguist George Kingsley Zipf. Zipf's Law demonstrates the usefulness of embodiments of the present invention wherein each word in a single language has an assigned numerical value determined by the frequency of use of that word.

Referring to Table 2, the first 26 words in a lexicon for both English and Spanish are shown. The numerical values were determined using the Brown Corpus, thus the words of Table 2 are the 26 most commonly used words in the base language English according to the Brown Corpus.

TABLE 2
Example Lexicons for English and Spanish

| Frequency | English | Spanish |
|---|---|---|
| 1 | The | El |
| 2 | Of | de |
| 3 | And | Y |
| 4 | A | Un |
| 5 | In | En |
| 6 | To | A |
| 7 | It | Lo |
| 8 | Is | Es |
| 10 | For | Para |
| 11 | That | Que |
| 12 | An | Una |
| 13 | He | Hombre |
| 14 | Be | Ser |
| 15 | With | Con |
| 16 | On | En |
| 17 | By | Por |
| 18 | At | En |
| 19 | Have | Tener |
| 20 | Are | Son |
| 21 | Not | No |
| 22 | But | Pero |
| 23 | Had | Habia |
| 24 | They, Them | Ellos |
| 25 | Which | Que |
| 26 | Or | O |

Using Table 2, expanded to include additional words, the sentence “He went with them to the restaurant by the way they knew” can be written in key talk as: “13 62 85 34 6 1 109 17 1 47 34 77”. Table 3 is a visual description of this sentence, in both English and Spanish, showing how either language can be written using relatively small base 10 integers when the words in each language are assigned numerical values determined by the frequency of use of that word in English as determined by the Brown Corpus.

TABLE 3
Example sentence in English, Key Talk and Spanish

| | | | | | | | | | | | |
|---|---|---|---|---|---|---|---|---|---|---|---|
| He | went | with | them | to | the | restaurant | by | the | way | they | knew |
| 13 | 62 | 85 | 34 | 6 | 1 | 109 | 17 | 1 | 47 | 34 | 77 |
| El | fue | con | ellos | a | el | restaurante | por | la | via | ellos | sagen |

The sentences exemplified in Table 3 have the same sentence structure in both English and Spanish. Sometimes, sentence structures vary slightly; however, the meaning of the sentence is still understandable. For example, the Spanish equivalent of the English: “The Bible is a very good book” is “La Biblia es un libro muy bueno.” Note the descriptive term “very good” appears before the noun “book” in English, while the equivalent descriptive term “muy bueno” appears after the noun “libro” in Spanish. Straight substitution of number for words could read “The Bible is a book very good” when delivered by a Spanish-speaking communicator and read by an English-speaking communicator. However, the meaning is still understandable to both. Thus, the sentence “The Bible is a very good book,” when written in key talk, is understandable by virtually any other language.

For example, Table 4 shows the sentence “The Bible is a very good book,” in English followed by the key talk version using numerical values for each word determined by the frequency of use of each word in English as determined by the Brown Corpus. The Spanish, French, and German sentences in Table 4 are then converted from the key talk sentence.

TABLE 4
Example Using Multiple Languages

| | | | | | | | |
|---|---|---|---|---|---|---|---|
| English | The | Bible | is | a | very | good | book |
| Key Talk | 1 | 147 | 8 | 4 | 55 | 111 | 147 |
| Spanish | La | Biblia | es | un | muy | bueno | libro |
| French | La | Bible | est | un | tres | bon | livre |
| German | Die | Bibel | ist | ein | sehr | gutes | Buch |

In some embodiments, a method for providing communication of information between communicators includes providing or receiving a plurality of lexicons wherein numerical values are given for each word determined by the frequency of use of the word as described above. The numerical values are transmitted via a wired or wireless telecommunication system, whereby information is communicated between the communicators by substituting numerical values for words representing the information communicated. The lexicons can be provided on paper, on a computer-readable storage medium, or can be downloaded from an Internet web site. Electronic lexicons can optionally include software making them searchable, i.e. inputting a number results in display of the corresponding word and inputting a word results in display of the corresponding number.

Nonlimiting examples of suitable wired or wireless telecommunication systems include telegraph, telephone, teletype, microwave communications, fiber optics and the Internet. Information is communicated between at least one first communication device and at least one communication device utilizing the wired or wireless telecommunication system. It is anticipated that text messaging on mobile phones utilizing key talk will be a popular. In some embodiments the numerical values are transmitted using a computing device, nonlimiting examples of which include smartphones, personal digital assistants (PDAs), tablet personal computers, pocket personal computers, notebook computers, desktop computers, and server computers.

In another embodiment of the present invention, a computer-readable storage medium stores a lexicon and a set of instructions capable of being executed by one or more computing devices, such that when executed in response to a user-input word, causes the one or more computing devices to search the lexicon for a stored word matching or best matching the user-input word. The lexicon has a plurality of words in at least one language, and each word in the lexicon has an assigned numerical value determined by the frequency of use of the word or an equivalent of the word in a base language. Once the stored word is found, the computing device is caused to display, on a display screen of the computing device, the numerical value assigned to that stored word in the lexicon.

Similarly, the executed instructions can cause the one or more computing devices to search the lexicon for a stored numerical value matching a user-input numerical value, and to display the word matching the stored numerical value.

Referring now to FIG. 2, a key talk system 10a is shown constructed in accordance with the present invention. In general, the key talk system 10a includes a plurality of code lexicons 12a, at least one first communicator 14a, at least one second communicator 16a, a signal path 18a, a signal path 20 and a signal path 22. The key talk system 10a provides communication between the at least one first communicator 14a and the at least one second communicator 16a. The plurality of code lexicons 12a is similar to the code lexicon 12. At least one first lexicon 12a is provided to the at least one first communicator 14a. The at least one first lexicon 12a has a plurality of words, phrases and concepts in the language of the at least one first communicator 14a which are assigned numerical values. At least one second lexicon 12a is provided to the at least one second communicator 16a. The at least one second lexicon 12a has a plurality of words, phrases and concepts in the language of the at least one second communicator 16a which are assigned numerical values, whereby conversation can be provided between the at least one first communicator 14a and the at least one second communicator 16a by altering numbers common to both the at least one first communicator and the at least one second communicator such that the at least one first communicator 14a readily communicates with the at least one second communicator 16a.

The signal path 18a may be an acoustical signal path, a visual signal path, a wired signal path or a wireless signal path. The signal path 18a can be logical and/or physical links and/or wireless links between various software and/or hardware utilized to implement the present invention. The physical links could be acoustic, optic fiber, copper wire, or coaxial cable communication links. The signal path 18a does not have to be a single signal path but may be multiple signal paths. In addition, it should be understood that the various information does not always have to flow between the components of the present invention in the exact manner shown provided the information is generated and received to accomplish the purposes set forth herein. The communication code may be transmitted vocally, visually, electronically (either analog or digital) or via telephone, television, radio, e-mail, post, text message or by combinations and derivations thereof.

From the above description it is clear that the presently disclosed and claimed inventive methods, devices and concepts are well adapted to attain the advantages mentioned herein as well as those inherent in the inventive methods, devices and concepts. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

### CITED REFERENCES

1. Brown University Standard Corpus of Present-Day American English, also Computational Analysis of Present-Day American English, (1967) Henry Kucera and W. Nelson Francis, Brown University, Providence, R.I.
2. The Lancaster-Oslo/Bergen Corpus (LOB Corpus), POS-tagged version (1981-1986), compiled by Geoffrey Leech, Lancaster University, Stig Johansson, University of Oslo (project leaders), Roger Garside, Lancaster University, and Knut Hofland, University of Bergen (heads of computing).
3. Frequency Analysis of English Usage: Lexicon and Grammar, by Winthrop Nelson Francis and Henry Kucera, Houghton Mifflin (January, 1983) ISBN 0-395-32250-2.

What is claimed is:

1. A method for providing communication of information between at least one first communicator and at least one second communicator, the method comprising:
receiving a plurality of lexicons wherein at least one first lexicon is received by at least one first communicator, the at least one first lexicon having a plurality of words in the language of the at least one first communicator, each word in the first lexicon having an assigned numerical value determined by the frequency of use of the word, or an equivalent of the word, in a base language, and wherein at least one second lexicon is received by at least one second communicator, the at least one second lexicon having a plurality of words in the language of the at least one second communicator, each word in the second lexicon having an assigned numerical value determined by the frequency of use of the word, or the equivalent of the word, in the base language; and
transmitting the numerical values via a wired or wireless telecommunication system, whereby information is communicated between the at least one first communicator and the at least one second communicator by substituting numerical values common to both the at least one first communicator and the at least one second communicator for words representing the information communicated.

2. The method of claim 1, wherein the numerical values are integers having a format selected from the group consisting of base 10, base 2, base 4, base 5, base 6, base 8, base 12, base 16, and base 20.

3. The method of claim 1, wherein the numerical values have a base 10 format.

4. The method of claim 1, wherein the base language is English.

5. The method of claim 1, wherein the frequency of use of each word is determined by the Brown University Standard Corpus of Present-Day American English (the“Brown Corpus”).

6. The method of claim 1, wherein at least one of the plurality of lexicons is provided on paper, on a computer-readable storage medium, or on a Web site downloadable to a computing device on the wired or wireless telecommunication system.

7. The method of claim 1, wherein the numerical values are transmitted between the at least one first communicator and the at least one second communicator via text messaging on a mobile phone.

8. The method of claim 1, wherein the numerical values are transmitted using a computing device selected from the group consisting of smartphones, personal digital assistants (PDAs), tablet personal computers, pocket personal computers, notebook computers, desktop computers, and server computers.

9. The method of claim 8, wherein the computing device comprises a computer-readable storage medium storing the lexicon and a set of instructions capable of being executed by the computing devices, that when executed by the computing device causes the computing device to:
search the lexicon for a stored word matching a user-input word, and to display on a display screen of the computing device, the numerical value assigned to the stored word in the lexicon matching the user-input word.

10. The method of claim 9, wherein the computing device is a smartphone.

11. The method of claim 9, wherein the set of instructions, when executed by the computing device, further causes the computing device to search the lexicon for a stored numerical value matching a user-input numerical value, and to display on the display screen of the computing device, the word having the assigned numerical value in the lexicon matching the user-input numerical value.

12. A computer-readable storage medium storing a lexicon and a set of instructions capable of being executed by one or more computing devices, that when executed by the one or more computing devices causes the one or more computing devices to:
search the lexicon for a stored word matching a user-input word, the lexicon having a plurality of words in at least one language, each word in the lexicon having an assigned numerical value determined by the frequency of use of the word or an equivalent of the word in a base language; and
display on a display screen of the computing device, the numerical value assigned to the stored word in the lexicon matching the user-input word.

13. The computer-readable storage medium of claim 12, wherein the set of instructions, when executed by the one or more computing devices, further causes the one or more computing devices to search the lexicon for a stored numerical value matching a user-input numerical value; and to display on a display screen of the computing device, the word having the assigned numerical value in the lexicon matching the user-input numerical value.

14. The computer-readable storage medium of claim 12, wherein the numerical values have a base 10 format.

15. The computer-readable storage medium of claim 12, wherein the base language is English.

16. The computer-readable storage medium of claim 12, wherein the computing device is a smartphone.

17. The computer-readable storage medium of claim 12, wherein the numerical value assigned to each stored word is determined by the frequency of use of the word as established by the Brown University Standard Corpus of Present-Day American English (the“Brown Corpus”).
